(19) United States
(12) Patent Application Publication
(10) Pub. No.: US 2014/0182553 A1
(43) Pub. Date: Jul. 3, 2014

(54) COMMON RAIL SYSTEM FOR DME FUEL

(71) Applicant: Hyundai Motor Company, Seoul (KR)

(72) Inventor: Ju Kwang Lee, Hwaseong-si (KR)

(73) Assignee: Hyundai Motor Company, Seoul (KR)

(21) Appl. No.: 13/892,709

(22) Filed: May 13, 2013

(30) Foreign Application Priority Data
Dec. 28, 2012 (KR) 10-2012-0156701

(51) Int. Cl. F02M 55/02

(52) U.S. Cl. CPC F02M 55/025
USPC 123/456

(57) ABSTRACT

A common rail system for a dimethyl ether (DME) fuel in which a medium-pressure fuel system is disposed between a low-pressure fuel system and a high-pressure fuel system to improve the durability and reliability of the common rail system is provided. The low-pressure fuel system stores a DME fuel in a gaseous state. The medium-pressure fuel system maintains a DME fuel supplied from the low-pressure fuel system to a high-pressure fuel system or returned from the high-pressure fuel system to the low-pressure fuel system in a liquid state. The high-pressure fuel system receives the DME fuel maintained in the liquid state from the medium-pressure fuel system and supplies the DME fuel to an injector.

### CROSS-REFERENCE TO RELATED PATENT APPLICATION

The present application claims priority of Korean Patent Application Number 10-2012-0156701 filed Dec. 28, 2012, the entire contents of which application is incorporated herein for all purposes by this reference.

### BACKGROUND OF INVENTION

1. Field of Invention

The present invention relates to a common rail system for a dimethyl ether (DME) fuel, and more particularly, to a common rail system for a DME fuel in which a medium-pressure fuel line is disposed between a low-pressure fuel line and a high-pressure fuel line so as to improve the durability and reliability of the common rail system.

2. Description of Related Art

Common rail engines using dimethyl ether (DME) as an alternative fuel have been recently developed. However, due to properties of a DME fuel, vaporization occurs frequently in the DME fuel. Thus, it is difficult to configure a system. When the properties of the DME fuel cannot be maintained in a liquid state, the durability of parts, i.e., fuel injection equipment (FIE), such as an injector, may be lowered.

In common rail systems for the DME fuel according to the related art, when a low-pressure pump makes a fuel in a liquid state by pressurizing the fuel, as 400 liters or more of the DME fuel per hour is pumped and supplied from a high-pressure pump to a common rail and the injector regardless of the amount of consumed fuel, a pumping loss of the high-pressure pump occurs.

In particular, as a return pressure of the DME fuel returned from the common rail and the injector is about 10 bar, when the temperature of the DME fuel rises to 40° or higher, the phase of the DME fuel is changed from a liquid phase to a gas phase so that lubrication and durability of the common rail system may be adversely affected.

Thus, a system for maintaining the properties of the DME fuel in the liquid state is required.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

Various aspects of the present invention provide for a common rail system for a dimethyl ether (DME) fuel in which a medium-pressure fuel system is disposed between a low-pressure fuel system and a high-pressure fuel system to maintain the DME fuel in a liquid state and to improve the reliability of the common rail system.

According to various aspects of the present invention, a common rail system for a dimethyl ether (DME) fuel includes a low-pressure fuel system that stores a DME fuel in a gaseous state, a medium-pressure fuel system that maintains a DME fuel supplied from the low-pressure fuel system to a high-pressure fuel system and/or a DME fuel returned from the high-pressure fuel system to the low-pressure fuel system in a liquid state, and the high-pressure fuel system that receives the DME fuel maintained in the liquid state from the medium-pressure fuel system and supplies the DME fuel to an injector.

The low-pressure fuel system may include a fuel tank that stores the DME fuel in a gaseous state, first and second final return lines that are connected to a return port of the fuel tank, a regulator and a check valve that are mounted on the first final return line, and a purge valve and a check valve that are mounted on the second final return line.

The high-pressure fuel system may include a high-pressure pump that pumps the DME fuel from the medium-pressure fuel system at a high pressure, a common rail that accommodates the DME fuel pumped by the high-pressure pump and supplies the DME fuel to the injector, and the injector that injects the DME fuel from the common rail into a combustion chamber so as to perform engine combustion.

The medium-pressure fuel system may include a low-pressure pump that supplies the DME fuel in the fuel tank to the high-pressure pump at a pressure at which the DME fuel is maintained in a liquid state, an accumulator that stores part of the DME fuel supplied from the low-pressure pump to the high-pressure pump and the DME fuel returned from the high-pressure fuel system, a fuel supply auxiliary line that is diverged from a fuel supply line and fluidically connected to the accumulator, wherein the fuel supply line is disposed between the low-pressure pump and the high-pressure pump, and a pressure regulating device that is disposed between the accumulator and the first final return line and maintains pressure of the accumulator at a predetermined pressure at which a returned fuel is maintained in a liquid state.

The first final return line on which the regulator and the check valve are mounted and the second final return line on which the purge valve and the check valve are mounted may be disposed between the accumulator and the fuel tank for returning the DME fuel to the fuel tank.

A driving revolutions per minute (RPM) of the low-pressure pump may be adjusted to supply a required amount of fuel by feeding back an amount of fuel injected by the injector and an amount of fuel supplied from the high-pressure pump to the common rail.

The common rail system may further include a cooling module that cools a fuel returned from the common rail, a surplus fuel returned from the injector, and a surplus fuel returned from the high-pressure pump before these fuels flow into the accumulator.

The pressure regulating device may include a back pressure regulator or a pressure control valve (PCV).

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a graph showing temperature versus vapor pressure of a dimethyl ether (DME) fuel; and

FIG. 2 illustrates an exemplary common rail system for a DME fuel according to various aspects of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

In accordance with various aspects of the present invention, a return pressure of a dimethyl ether (DME) fuel in a liquid state-maintaining condition may be maintained so as to guarantee lubrication and durability of parts, such as a high-pressure pump and fuel injection equipment (FIE) of a common rail system. Due to properties of the DME fuel, the DME fuel has properties of gas when it is stored; a return pressure of the DME fuel is low and a phase of the DME fuel is changed from a liquid phase to a gas phase. Consequently, the durability of a common rail system is lowered.

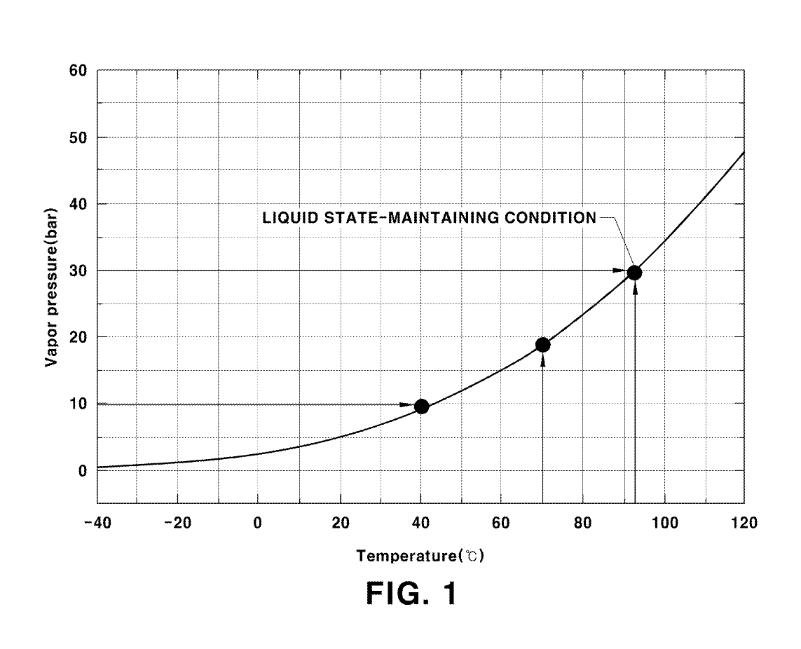

That is, as shown in FIG. 1, in order to prevent the DME fuel from being vaporized when a return pressure of the DME fuel is about 10 bar and the temperature of the DME fuel rises to 40° C. or higher, a return temperature of the DME fuel is adjusted to 90° C. and simultaneously, a fuel supply and return pressure is adjusted to 30 bar so that the DME fuel can be maintained in the liquid state-maintaining condition.

To this end, a common rail system for a DME fuel according to various embodiments of the present invention includes a low-pressure fuel system 100 that stores the DME fuel in a gaseous state, a medium-pressure fuel system 200 that maintains the DME fuel supplied from the low-pressure fuel system 100 to a high-pressure fuel system 300 and the DME fuel returned from the high-pressure fuel system 300 to the low-pressure fuel system 100 in a liquid state, and the high-pressure fuel system 300 that receives the DME fuel maintained in the liquid state from the medium-pressure fuel system 200 and finally supplies the DME fuel to an injector 303.

The low-pressure fuel system 100 includes a fuel tank 101 that stores the DME fuel in a gaseous state, first and second final return lines 102 and 103 that are connected to a return port of the fuel tank 101, a regulator 104 and a check valve 105 that are mounted on the first final return line 102, and a purge valve 106 and a check valve 107 that are mounted on the second final return line 103. In this case, the fuel tank 101 may be a gas storing tank for a liquid propane injection (LPI) system.

The high-pressure fuel system 300 has similar or substantially the same structure as a structure used in a common rail system for a diesel engine. The high-pressure fuel system 300 includes a high-pressure pump 301 that pumps the DME fuel from the medium-pressure fuel system 200 at a high pressure, a common rail 302 that accommodates the DME fuel pumped by the high-pressure pump 301 and supplies the DME fuel to the injector 303, and the injector 303 that injects the DME fuel from the common rail 302 into a combustion chamber so as to perform engine combustion.

In particular, the medium-pressure fuel system 200 is configured to have a liquid state-maintaining condition (for example, fuel temperature 90°, 30 bar of fuel supply and return pressure) not to vaporize the DME fuel supplied to the high-pressure fuel system 300 and the DME fuel returned to the low-pressure fuel system 100.

As one configuration of the medium-pressure fuel system 200, a low-pressure pump 202 is mounted on a fuel supply line 201 that extends from a supply port of the fuel tank 101 and is connected to the high-pressure pump 301.

The low-pressure pump 202 pressurizes the DME fuel (that may exist both in a gaseous state and a liquid state) that is discharged from the fuel tank 101 at the pressure of about 6 to 10 bar, to the pressure of about 20 to 30 bar so as to maintain the DME fuel in the liquid state.

In this case, a driving revolutions per minute (RPM) of the low-pressure pump 202 is adjusted or controlled so as to supply only a required amount of flow by feeding back the amount of fuel injected by the injector 303 and the amount of fuel supplied from the high-pressure pump 301 to the common rail 302 so that a pumping loss caused by the supply of an unnecessary amount of flow can be prevented.

In addition, a cooling fan 203 is further disposed between the low-pressure pump 202 and the high-pressure pump 301 so as to cool the DME fuel pressurized at a low pressure (about 30 bar) not to rise up to a reference temperature.

A fuel returned when the pressure in the common rail 302 exceeds a reference value, a surplus fuel from the injector 303, and a surplus fuel from the high-pressure pump 301 are discharged through first, second, and third return lines 304, 305, and 306. Thus, a cooling module 204 is mounted on ends of the first, second, and third return lines 304, 305, and 306.

In this case, since the fuel returned from the common rail 302 and the injector 303 is heated by a high pressure, the cooling module 204 cools the fuel returned from the common rail 302 and the injector 303 to a predetermined temperature.

As another configuration of the medium-pressure fuel system 200, an accumulator 205 is mounted on a discharge port of the cooling module 204.

The first and second final return lines 102 and 103 are connected to the accumulator 205 so as to return the DME fuel to the fuel tank 101, and the regulator 104 and the check valve 105 are mounted on the first final return line 102 connected to the fuel tank 101, as described above, and the purge valve 106 and the check valve 107 are sequentially mounted on the second final return line 103.

Also, a fuel supply auxiliary line 206 that is connected to the fuel supply line 201 connected from the low-pressure pump 202 to the high-pressure pump 301 is connected to the accumulator 205.

In this case, the accumulator 205 stores the fuel returned from the cooling module 204 and stores a surplus fuel that may be supplied from the low-pressure pump 202 to the high-pressure pump 301.

As another configuration of the medium-pressure fuel system 200, a pressure regulating device 207, such as a back pressure regulator or a pressure control valve (PCV), is disposed between the accumulator 205 and the regulator 104 of the first final return line 102 and adjusts the returned fuel at a predetermined pressure so as to maintain the returned fuel in a liquid state.

Here, the flow of an operation of the common rail system for the DME fuel having the above structure will be described as below.

First, if an engine is turned on (IG On) for engine operation, the low-pressure pump 202 operates in a maximum flow condition by control of an engine control unit (ECU) so that the medium-pressure fuel system 200 is configured at a medium pressure.

That is, the low-pressure pump 202 pressurizes the DME fuel (that may exist both in a gaseous state and a liquid state) discharged from the fuel tank 101 at the pressure of about 6 to 10 bar, to the pressure of about 30 bar so as to maintain the DME fuel in the liquid state.

The driving RPM of the low-pressure pump 202 may be adjusted or controlled so as to supply only a required amount of flow or fuel by feeding back the amount of fuel injected by the injector 303 and the amount of fuel supplied from the high-pressure pump 301 to the common rail 302 so that a pumping loss caused by the supply of an unnecessary amount of flow can be prevented.

The reason why the fuel is pressurized from the low-pressure pump 202 to the high-pressure pump 301 at 30 bar is that the fuel in the FIE (the high-pressure pump, the common rail, the injector, and the like) is maintained in the liquid state so that smooth lubrication and durability of the FIE can be improved.

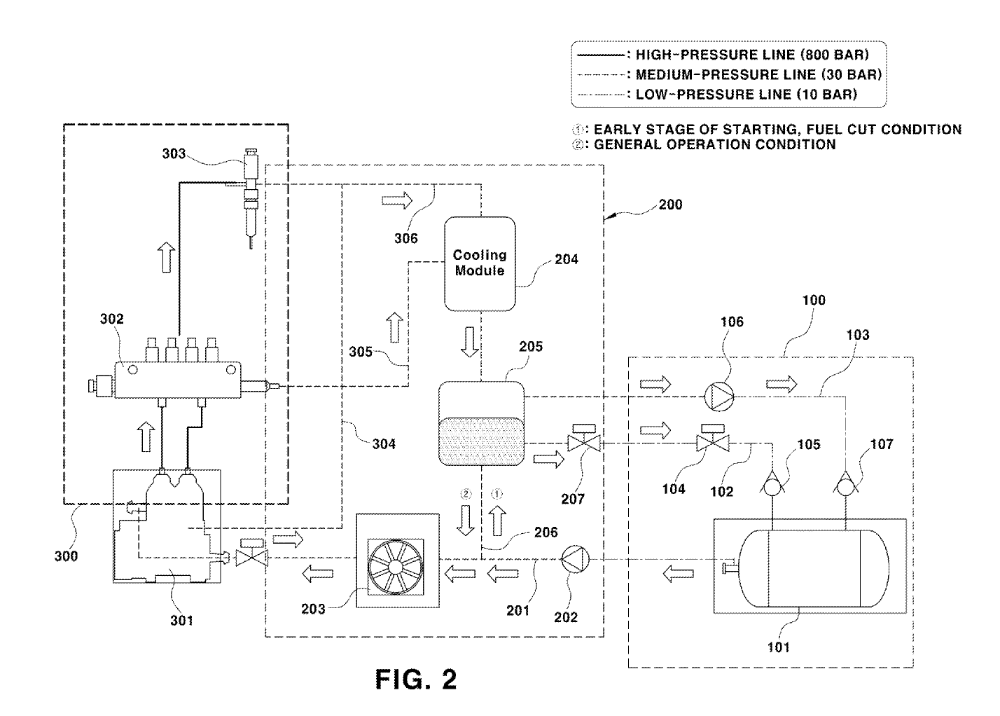

In this case, the DME fuel supplied from the low-pressure pump 202 is supplied to the accumulator 205 along the fuel supply auxiliary line 206 in addition to the high-pressure pump 301, as indicated by \textcircled{1} of FIG. 2, in an early stage of starting or fuel cut condition so that a supply pressure of the DME fuel supplied from the low-pressure pump 202 to the high-pressure pump 301 can be adjusted to a predetermined pressure (20 to 30 bar).

In more detail, in an operation condition in which a rapid fuel pressure variation may occur, like the case that the amount of consumed fuel is rapidly decreased due to car rapid parking or non-load driving (fuel cut driving) or the case that the amount of consumed fuel is increased due to rapid acceleration, the DME fuel supplied from the low-pressure pump 202 is supplied to the accumulator 205. As a result, the accumulator 205 adjusts the fuel supply pressure to the predetermined pressure (20 to 30 bar). Thus, the durability and stability of parts of the FIE can be improved.

In this way, when the low-pressure pump 202 pressurizes the DME fuel at the pressure of 20 to 30 bar and supplies the DME fuel to the high-pressure pump 301, the high-pressure pump 301 pressurizes the DME fuel at the high pressure of about 800 bar and supplies the DME fuel to the common rail 302. The DME fuel in the common rail 302 is injected into an engine combustion chamber by the injector 303.

In this case, a surplus fuel that does not come into the common rail 302 of the whole of the fuel supplied from the low-pressure pump 202 to the high-pressure pump 301, is returned to the cooling module 204 through the third return line 306, and a fuel that is purged from the common rail 302 when the pressure in the common rail 302 exceeds a predetermined value, is returned to the cooling module 204 through the second return line 305. A surplus fuel from the injector 303 is returned to the cooling module 204 in a gaseous state.

A surplus DME fuel that is returned from the common rail 302 and the injector 303 in addition to the high-pressure pump 301, is collected in the accumulator 205 via the cooling module 204. In this case, the pressure of the accumulator 205 is uniformly adjusted by the pressure regulating device 207, such as a back pressure regulator or a pressure control valve (PCV). Also, the fuel collected in the accumulator 205 is not directly returned to the fuel tank 101 but serves as a reservoir for supplying the fuel again to the high-pressure pump 301.

Thus, the fuel stored in the accumulator 205 apart from the fuel supplied from the low-pressure pump 202 to the high-pressure pump 301 is supplied to the high-pressure pump 301, as indicated by \textcircled{2} of FIG. 2. Thus, the low-pressure pump 202 supplies only the amount of fuel apart from the fuel supplied from the accumulator 205 of the whole fuel supply amount so that a pumping loss of the low-pressure pump 202 can be reduced.

If the amount of fuel stored in the accumulator 205 exceeds a reference value, the fuel that exceeds the reference value is discharged through the second final return line 103 and then passes through the purge valve 106 and the check valve 107 and is returned to the fuel tank 101.

Also, the amount of fuel discharged from the pressure regulating device 207 so as to uniformly adjust the pressure of the accumulator 205, passes through the regulator 104 and the check valve 105 mounted on the first final return line 102 and then is returned to the fuel tank 101.

As described above, various aspects of the present invention provide many advantages. For instance, a medium-pressure fuel system that is disposed between a high-pressure fuel system (a high-pressure pump, a common rail, and an injector) and a low-pressure fuel system (a fuel tank) and that maintains a supply and return pressure of a fuel at about 20 to 30 bar, is configured so that the DME fuel can be maintained in a liquid state. As the DME fuel is maintained in the liquid state, lubrication and durability of the high-pressure fuel system can be improved.

An accumulator for storing a supply and return fuel is disposed in the medium-pressure fuel system, and a line pressure of the medium-pressure fuel system including the accumulator is uniformly adjusted by using a pressure regulating device, such as a back pressure regulator or a pressure control valve (PCV), so that the fuel can be maintained in the liquid state.

The accumulator stores part of the supply fuel in a rapid operation condition-varying (rapid acceleration, fuel cut) condition, thereby serving as a damper that protects parts of the high-pressure fuel system.

After the returned fuel is cooled and is stored in the accumulator, it is supplied again to a high-pressure pump, and only the amount of fuel apart from a fuel supplied from the accumulator of the whole supply fuel amount is supplied from a low-pressure pump to the high-pressure pump so that a pumping loss of the low-pressure pump can be reduced.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A common rail system for a dimethyl ether (DME) fuel, comprising:
a low-pressure fuel system that stores a DME fuel in a gaseous state;
a medium-pressure fuel system that maintains a DME fuel supplied from the low-pressure fuel system to a high-pressure fuel system or returned from the high-pressure fuel system to the low-pressure fuel system in a liquid state; and
the high-pressure fuel system that receives the DME fuel maintained in the liquid state from the medium-pressure fuel system and supplies the DME fuel to an injector.

2. The common rail system of claim 1, wherein the low-pressure fuel system comprises:
a fuel tank that stores the DME fuel in a gaseous state;
first and second final return lines that are connected to a return port of the fuel tank;
a regulator and a check valve that are mounted on the first final return line; and
a purge valve and a check valve that are mounted on the second final return line.

3. The common rail system of claim 1, wherein the high-pressure fuel system comprises:
a high-pressure pump that pumps the DME fuel from the medium-pressure fuel system at a high pressure;
a common rail that accommodates the DME fuel pumped by the high-pressure pump and supplies the DME fuel to the injector; and
the injector that injects the DME fuel from the common rail into a combustion chamber to perform engine combustion.

4. The common rail system of claim 1, wherein the medium-pressure fuel system comprises:
a low-pressure pump that supplies the DME fuel in the fuel tank to the high-pressure pump at a pressure at which the DME fuel is maintained in a liquid state;
an accumulator that stores part of the DME fuel supplied from the low-pressure pump to the high-pressure pump and the DME fuel returned from the high-pressure fuel system;
a fuel supply auxiliary line that is diverged from a fuel supply line and fluidically connected to the accumulator, wherein the fuel supply line is disposed between the low-pressure pump and the high-pressure pump; and
a pressure regulating device that is disposed between the accumulator and the first final return line and maintains pressure of the accumulator at a predetermined pressure at which a returned fuel is maintained in a liquid state.

5. The common rail system of claim 4, wherein the first final return line and the second final return line are disposed between the accumulator and the fuel tank for returning the DME fuel to the fuel tank.

6. The common rail system of claim 4, wherein a driving revolutions per minute (RPM) of the low-pressure pump is adjusted to supply a required amount of fuel by feeding back an amount of fuel injected by the injector and an amount of fuel supplied from the high-pressure pump to the common rail.

7. The common rail system of claim 4, further comprising a cooling module that cools a fuel returned from the common rail, a surplus fuel returned from the injector, and a surplus fuel returned from the high-pressure pump before these fuels flow into the accumulator.

8. The common rail system of claim 4, wherein the pressure regulating device comprises a back pressure regulator or a pressure control valve (PCV).
